(19) United States
(12) Patent Application Publication
(10) Pub. No.: US 2014/0037920 A1
(43) Pub. Date: Feb. 6, 2014

(54) PATTERNING OF HARD-TO-DRY-ETCH SUBSTRATES

(71) Applicant: Boris Kobrin, Dublin, CA (US)

(72) Inventor: Boris Kobrin, Dublin, CA (US)

(73) Assignee: Rolith, Inc., Pleasanton, CA (US)

(21) Appl. No.: 13/564,637

(22) Filed: Aug. 1, 2012

(51) Int. Cl. B44C 1/22; B32B 3/10; C03C 25/68

(52) U.S. Cl. 428/210; 216/58; 216/80; 216/41; 428/195.1

(57) ABSTRACT

A hard-to-dry-etch material may be patterned by forming a layer of dry-etchable material on a surface of the hard-to-dry etch substrate, and dry etching the dry-etchable material. The hard-to-dry etch substrate produces substantial quantities of non-volatile etch byproducts that redeposit when subject to the dry etching. The dry-etchable material has similar material properties to the hard-to-dry-etch substrate material is formed. The dry-etchable material is one that does not produce substantial quantities of non-volatile etch byproducts that redeposit when the dry-etchable material is subject to the dry etching. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### FIELD

Embodiments of the invention relate to patterning of substrates and more particularly patterning substrate that are difficult to dry-etch.

### BACKGROUND

This section describes background subject matter related to the disclosed embodiments of the present invention. There is no intention, either express or implied, that the background art discussed in this section legally constitutes prior art.

Patterned substrates and structured coatings have attractive properties for a variety of applications, including architectural glass, information displays, solar panels, and more. For example, nanostructured coatings can provide desirable antireflection characteristics for architectural glass. Current methods of patterning substrates, include lithographic methods such as electron beam lithography, photolithography, interference lithography, imprint lithography and other methods. These methods generally involve forming a layer of radiation sensitive material on a surface of the substrate and exposing the material, or selected portions of the material to radiation. The radiation exposure changes the physical or chemical properties of the material in such a way that a pattern is transferred to the material in a process known as developing the resist. By way of example, in photolithography, a layer of radiation sensitive photoresist is exposed to radiation that is transmitted through some form of patterned mask. As a result of the mask, selected portions of the resist are exposed to the radiation and others are not.

Depending on the type of resist, the radiation exposure either cures the resist to make exposed portions resistant to removal or weakens the exposed portions making them susceptible to removal. The developing process removes the un-exposed (or exposed) portions of the resist to transfer the pattern to the resist. The pattern may have openings that allow a chemical or physical etch process to attack the underlying substrate and remove material from it.

One type of etch process is known as a dry etch process. In this type of etch process, reactive species are directed toward the substrate so that the etching preferentially takes place in one direction. Dry etch processes often use plasma to generate reactive ions that can be directed toward the substrate by an electric field.

It would be desirable to nanostructure many types of substrate materials with dry etching for applications in many present technologies and industries and for new technologies that are under development. By way of example and not by way of limitation, such nanostructuring could lead to improvements in efficiency in areas such as solar cells and LEDs, creating new advanced features in products such as glass for displays and architectural windows.

Nanostructured substrates may be fabricated using dry etching in conjunction with conventional lithographic patterning techniques, such as e-beam direct writing, Deep UV lithography, nanosphere lithography, nanoimprint lithography, near-filed phase shift lithography, and plasmonic lithography, for example. A drawback to such conventional lithographic patterning processes is that they are often too costly for practical use in the manufacture of patterned substrates or structured coatings in applications requiring larger areas, especially those having areas of 200 cm² or more. Some previous techniques for patterning large area substrates and the drawbacks of such techniques are described in commonly-assigned U.S. patent application Ser. No. 12/384,219, filed Apr. 1, 2009, the entire contents of which are incorporated herein by reference.

Another drawback to existing patterning techniques that use dry etching is that though dry etching has been successfully used on relatively pure substrate materials such as metals, semiconductors (e.g., silicon) or insulators (e.g., quartz) many types of substrate materials are hard to dry etch. Such hard-to-dry-etch substrate materials include architectural glass and other type so glass used in flat panel displays and other applications.

It is within this context that a need for the present invention arises.

### SUMMARY

Aspects of the present disclosure pertain to methods and apparatus useful in patterning hard-to-dry-etch substrates. By way of example and not by way of limitation, such substrates may be large area substrates, which may range in size from about 200 mm² to about 1,000,000 mm², or more. In some instances the substrate may be in the form of a sheet or film, which has a given width and an undefined length, which may be provided on a roll.

Generally, a layer of dry-etchable material having similar material properties to the hard-to-dry-etch substrate material is formed on a surface of the hard-to-dry etch substrate. The dry-etchable material may be formed to a thickness that is greater than or equal to a desired etch depth. An etch-resistant mask may be formed on the dry-etchable material. The etch-resistant mask may be patterned using a suitable patterning technique. The dry-etchable material may be dry-etched through one or more openings in the etch-resistant mask.

By way of example and not by way of limitation, the hard-to-etch substrate material may be a form of commercially available glass, such as architectural glass. In such a case, the dry-etchable material may be silica (SiO₂) layer, which has a similar index of refraction and similar coefficient of thermal expansion (CTE) compared to glass. Alternatively, the dry-etchable material may be titania (TiO₂), which can be dry etched to form conical features.

By way of example, and not by way of limitation, the patterning technique used to pattern the dry-etchable material may make use of Near-Field UV photolithography, where the mask used to pattern the substrate is in contact or in very close proximity (in the evanescent field, less than 100 nm) from the substrate. The Near-Field photolithography may include a phase-shifting mask or surface plasmon technology.

According to an aspect of the present disclosure, the exposure apparatus may include a phase-shifting mask in the form of a UV-transparent rotatable mask having specific phase shifting relief on its outer surface. According to another aspect, the phase-shifting mask may be in the form of a transparent cylinder, which may have a polymeric film configured to act as a phase-shifting mask. The film can be attached to the cylinder's outer surface. In situations where it is difficult to obtain good and uniform contact with the substrate surface, especially for large processing areas, it is advantageous to have the polymeric film be a conformal, elastomeric polymeric film such as PMDS, which makes excellent conformal contact with the substrate through Van-der Waals forces. The polymeric film phase-shifting mask may consist of multiple layers. An outer layer may be nanopatterned to more precisely represent prescribed feature dimensions in a radiation-sensitive (photosensitive) layer.

### BRIEF DESCRIPTION OF THE DRAWINGS

The teachings of the present invention can be readily understood by considering the following detailed description in conjunction with the accompanying drawings. It is to be appreciated that drawings are provided only when necessary to understand certain aspects of the present disclosure and that certain well known processes and apparatus are not illustrated herein in order not to obscure the inventive nature of the subject matter of the disclosure.

FIG. 1A shows a cross-sectional view of one embodiment of an apparatus 100 useful in patterning of large areas of substrate material in conjunction with aspects of the present disclosure.

FIG. 1B shows a top view of the apparatus and substrate illustrated in FIG. 1A.

FIG. 2 shows a cross-sectional view of another embodiment of an apparatus 200 useful in patterning of large areas of substrate material in conjunction with aspects of the present disclosure.

FIGS. 3A-3D are a sequence of cross-sectional diagrams illustrating patterning of a hard-to-dry-etch substrate using dry etching in accordance with an aspect of the present disclosure.

FIGS. 4A-4E are a sequence of cross-sectional diagrams illustrating patterning of a hard-to-dry-etch substrate using dry etching in accordance with an alternative aspect of the present disclosure.

### DETAILED DESCRIPTION

As a preface to the detailed description, it should be noted that, as used in this specification and the appended claims, the singular forms “a”, “an”, and “the” include plural referents, unless the context clearly dictates otherwise.

When the word “about” is used herein, this is intended to mean that the nominal value presented is precise within ±10%. Furthermore, In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

Aspects of the present disclosure relate to methods and apparatus useful in the nanopatterning of large area substrates using dry-etching.

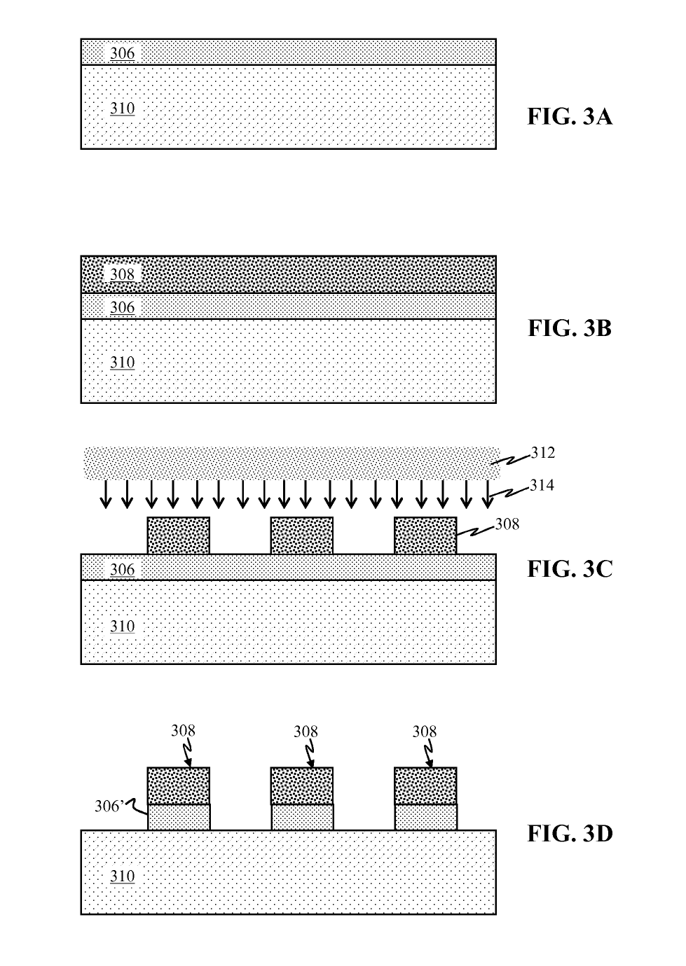

FIGS. 3A-3D illustrate a processing sequence by which a hard-to-dry-etch substrate 310 may be patterned using dry etching. First, as shown at FIG. 3A, a layer of physically compatible dry-etchable material 306 may be formed on a surface of the substrate 310. Generally, the dry-etchable material 306 has similar physical properties to the material of the substrate 310. For example, the substrate 310 and dry-etchable material 306 may have the same or similar chemical composition. In addition the substrate 310 and dry-etchable material may have similar physical properties if they are similarly transparent in a given range of wavelengths of the electromagnetic spectrum (e.g., the visible wavelength range), if they are similarly colorless (or colored), or if they are as mechanically and/or chemically stable as each other. The substrate 310 produces substantial quantities of non-volatile etch by products that redeposit when the substrate is subject to dry-etching. The dry-etchable material 306 is one that does not produce substantial quantities of non-volatile etch byproducts that redeposit when the dry-etchable material is subject to the dry etching.

An example of a suitable combination of substrate and dry-etchable materials would be where the substrate is made of glass and the dry-etchable material is fused silica both of which are different forms of silicon dioxide (SiO₂). The main difference is that a glass used in FPD and architectural windows has a lot of different additives (dopants) in the silicon oxide network. These dopants make dry etching process very challenging since the doping materials are usually metals and they don't easily form a volatile components during etching process, which could be evacuated from the vacuum chamber. Instead they get redeposited (sputtered) on top of the etched features, which reduces the etching rate) and between the etched features (creating a rough surface—sometimes referred to as “grass”). Alternatively, the substrate 310 and dry etchable material may have different chemical compositions but similar physical properties, such as similar refractive indices or similar coefficients of thermal expansion. The closeness of the physical properties depends on specific requirements of the product being fabricated. For example, if the product is to be used in-home, CTE differences are not so important. If the product is to be used outside the home (e.g., for an exterior window), CTE differences are more important due to a potentially greater differences in temperature on opposite sides of the glass. In other implementations, the substrate and dry etchable material may have the same or similar chemical composition and similar physical properties.

By way of example, and not by way of limitation the dry-etchable material 306 can be deposited using any of the known deposition methods: from the liquid phase by spinning, roller coatings, knife-edge coating, spraying, inkjet printing, dipping, etc.; from the vacuum phase: sputtering, CVD, PVD, MVD, MBE, etc. In some implementations, once the dry-etchable material has been deposited, it may optionally be baked or annealed or cured.

Next, as shown in FIG. 3B, a layer of masking material (e.g., a metal or photoresist) may be formed on the dry-etchable material and patterned to form an etch mask. In some implementations, the mask may be formed of radiation-sensitive material (e.g., photoresist), which may be patterned by a suitable lithographic process to form a mask. Alternatively, a layer of metal may be formed on the dry-etchable material 306 and the metal may be patterned (e.g., by photolithography) to produce the mask. By way of example, and not by way of limitation, a radiation sensitive material 308 (e.g., photoresisit) may be deposited onto a surface of the dry-etchable material 306. By way of example, and not by way of limitation, the radiation sensitive material 308 may be deposited onto the dry-etchable material 306 by spin-coating. In some implementations, once the radiation sensitive material 308 has been deposited, the radiation sensitive material 308 may optionally be soft-baked. Soft-baking may be performed in order to drive away the solvent from the spun-on radiation sensitive material 308, to improve the adhesion of the resist to the substrate 310; and to reduce shear stresses that may have been introduced during the deposition of the radiation sensitive material 308. By way of example and not by way of limitation, soft baking may be performed using one of several types of ovens (e.g., convection or a hot plate) at a temperature of approximately 100° C. By way of example, and not by way of limitation, the soft back may take place at a temperature of about 80-120° C. for a period of time ranging from about 30 seconds to about one minute.

The radiation sensitive material 308 may be exposed to radiation, through the use of any of any suitable technique, include but not limited to the rolling mask lithography techniques described above. By way of example, and not by way of limitation, the rolling mask lithography may use a phase shifting mask, a PDMS photomask, or surface plasmon technology. Following exposure to radiation, the exposed radiation sensitive material 308 may be developed. FIG. 3C is a diagram of the substrate 310 and the radiation sensitive material 308 after the radiation sensitive material has been developed to form an etch-resistant mask. The dry-etchable material 306 may be one that can be etched with a rate faster/or much faster than the material of the etch-resistant mask formed by developing the radiation sensitive material 308.

Although FIG. 3C shows a mask having features with non-sloped (e.g., rectangular or vertical) sidewalls, other sidewall configurations, e.g., sloped sidewall configurations, are also possible. For example, according to some aspects of the present disclosure, the radiation sensitive material 308 may optionally be reflown. Reflowing the radiation sensitive material 308 may be accomplished by heating the radiation sensitive material 308 to a temperature above the material's glass transition temperature. By way of example, and not by way of limitation, the radiation sensitive material 308 may be heated to a temperature in a range from about T_{g}+80° C. to T_{g}+200° C. The time for reflow may be in a range between about 10 min and about 10 hours, depending on the specific radiation sensitive material that is used. Reflowing the radiation sensitive material may be used, e.g., to soften sharp corners of the developed radiation sensitive material 308 and produce sloped features along sidewalls. The slope and the radius of curvature of the features may be controlled by adjusting the heating temperatures and times. Sloped features in the patterned radiation sensitive material 308 may be translated into substrate 310 during subsequent etching processes.

According to additional aspects of the present disclosure, the structures formed in the radiation sensitive material 308 may also optionally be transformed into curved surfaces through the use a multi-level photoresist structure with layers that have different values for their index of refraction. By way of example, and not by way of limitation, one can use a multi-level photoresist structure with each layer having different refractive index, so that the total structure has a gradient of refractive index across the thickness. This way one can change the profile of light distribution in the photoresist to engineer a sloped profile as a result of such exposure/development process.

As shown in FIG. 3C, the dry-etchable material 306 may be dry etched to a desired depth. The depth is generally less than or equal to a thickness of the dry-etchable material 306. By way of example, a plasma 312 may be generated in the vicinity of the substrate 310. A voltage may be applied between the plasma and the substrate 310 or between the plasma and a support on which the substrate rests or is retained. The plasma may be sustained by a DC or AC discharge in a suitable configured processing chamber. It is noted that AC plasma is commonly used for etching dielectric materials. The voltage directs ions 314 from the plasma toward the substrate 310. The ions remove selected portions of the dry-etchable material that are not protected by the developed radiation sensitive material 308. By way of example, e.g., by direct physical attack (sputtering), by chemical reaction, or by some combination of physical attack and chemical reaction. The depth of etching may be controlled e.g., by adjusting plasma parameters that control the etch rate and accordingly adjusting the time of etching. The dry-etchable material 306 may be configured to block dry etching of underlying portions of the hard-to-dry-etch substrate 310 during the dry etch process. In such a case, the hard-to-dry-etch substrate may act as an etch stop for the dry etching of the dry-etchable material.

As a result of the etch process, a patterned is transferred from the developed radiation sensitive layer 308 to the dry-etchable layer forming structures 306′, as shown in FIG. 3D. Depending on the patterning process used to pattern the radiation sensitive layer 308 to form the etch-resistant mask, features ranging in size from about 10 nm to about 10 microns may be formed in the dry-etchable material 306. It is noted that by forming the dry-etchable layer 306 on the hard-to-dry-etch substrate 310, the accuracy of etching depth may be drastically improved since it is usually much easier to assure accuracy of thin film deposition than accuracy of etch depth.

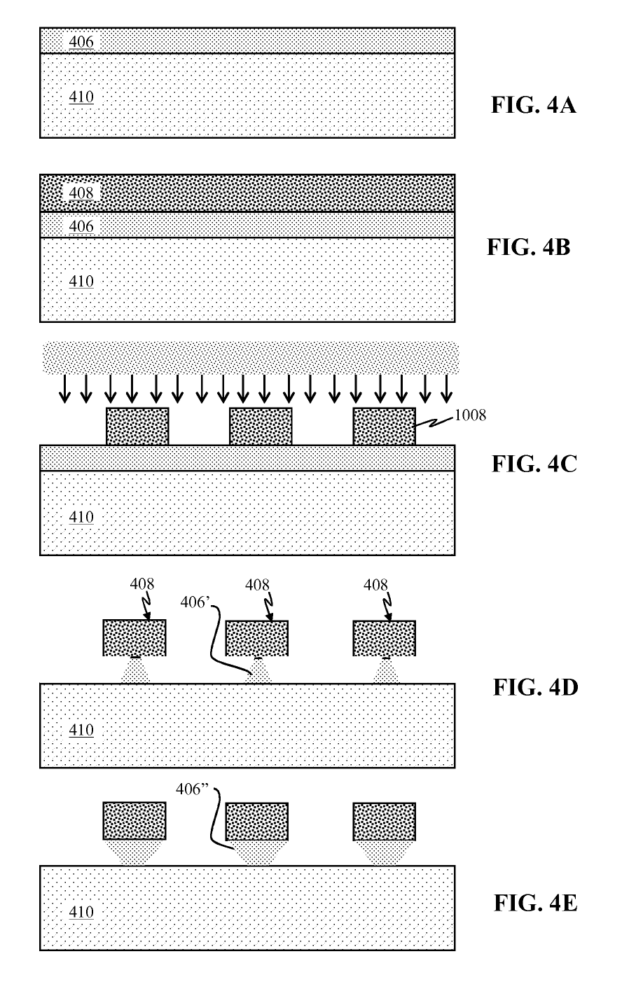

According to alternative aspects of the present disclosure the process of FIGS. 3A-3D may be modified by using a dry-etchable material that is selected such that the etching process forms tapered structures. FIGS. 4A-4D illustrate an example of such a process. The process proceeds in essentially the same sequence as in FIGS. 3A-3D. Specifically, in FIG. 4A a dry-etchable material 406 is formed on a hard-to-dry-etch substrate 410. As radiation sensitive layer 408 is formed over the dry-etchable material, as shown in FIG. 4B. The radiation sensitive layer 408 is patterned and developed and the dry-etchable material 406 is etched, e.g., using a plasma process as shown in FIG. 4C. In this example, the dry etching process 406 is optimized such that the etch propagates not only in the vertical direction but also in the horizontal direction and the process produces tapered features 406′. Alternatively, the etch process may be configured to produce sloped other than tapered or cone-shaped features. For example, FIG. 4E illustrates an example of re-entrant features 408″ that may be obtained through suitable selection of the dry-etchable material and dry etch process.

An alternative method of getting a sloped wall features (cone-shaped features, for example) is to use a photoresist reflow process and then transfer sloped photoresist mask features into the dry-etchable material.

By way of example and not by way of limitation, the dry-etchable material 406 may be Titania (TiO₂) and the substrate material 410 may be commercial grade glass, such as architectural glass. As a result of the etch process, the TiO₂ may be pattered with “moth-eye” structures that are anti-reflecting.

An added benefit of using TiO₂ is that it is also self-cleaning. Organic contaminants on TiO₂ decompose when exposed to a light having UV component, such as sunlight. The decomposition turns the surface of the TiO₂ to a super hydrophilic state. Water sheets on such a surface, thereby facilitating removal of loosely bound contaminants.

According to certain aspects of the present disclosure a rotatable mask may be used to pattern the radiation-sensitive material. The rotatable mask may be in the form of a cylinder. Nanopatterning with a rotatable mask may use techniques that make use of near-field photolithography, where the wavelength of radiation used to image a radiation-sensitive layer on a substrate is 650 nm or less, and where the mask used to pattern the substrate is in contact with the substrate. The near-field photolithography may make use of a phase-shifting mask, or nanoparticles on the surface of a transparent rotating cylinder, or may employ surface plasmon technology, where a metal layer on the rotating cylinder surface comprises nano holes. The detailed description provided below is just a sampling of the possibilities which will be recognized by one skilled in the art upon reading the disclosure herein.

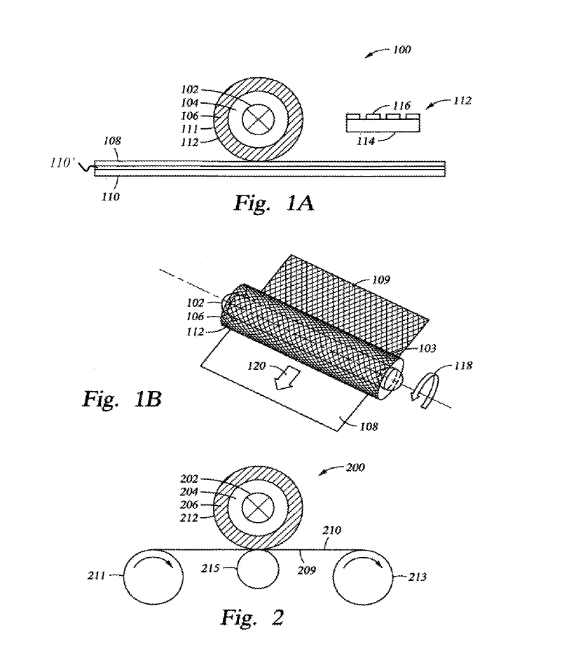

Although the rotating mask used to generate a nanopattern within a layer of radiation-sensitive material may be of any configuration which is beneficial, and a number of these are described below, a hollow cylinder is particularly advantageous in terms of imaged substrate manufacturability at minimal maintenance costs. FIG. 1A shows a cross-sectional view of one example of an apparatus 100 useful in patterning of large areas of substrate material, where a radiation transparent cylinder 106 has a hollow interior 104 in which a radiation source 102 resides. In this embodiment, the exterior surface 111 of the cylinder 106 is patterned with a specific surface relief 112. The cylinder 106 rolls over a radiation sensitive material 108 which overlies a layer of dry-etchable material 110′ on a hard-to-dry etch substrate 110. FIG. 1B shows a top view of the apparatus and substrate illustrated in FIG. 1A, where the radiation sensitive material 108 has been imaged 109 by radiation (not shown) passing through surface relief 112. The cylinder rotates in the direction shown by arrow 118, and radiation from a radiation source 102 passes through the nanopattern 112 present on the exterior surface 103 of rotating cylinder 106 to image the radiation-sensitive layer (not shown) on substrate 108, providing an imaged pattern 109 within the radiation-sensitive layer. The radiation-sensitive layer is subsequently developed to provide a nanostructure on the surface of substrate 108. In FIG. 1B, the rotatable cylinder 106 and the substrate 120 are shown to be independently driven relative to each other. In another embodiment, the substrate 120 may be kept in dynamic contact with a rotatable cylinder 106 and moved in a direction toward or away from a contact surface of the rotatable cylinder 106 to provide motion to an otherwise static rotatable cylinder 106. In yet another embodiment, the rotatable cylinder 106 may be rotated on a substrate 120 while the substrate is static.

By way of Example, and not by way of limitation, the specific surface relief 112 may be etched into the exterior surface of the transparent rotating cylinder 106. Alternatively, the specific surface relief 112 may be present on a film of polymeric material which is adhered to the exterior surface of rotating cylinder 106. The film of polymeric material may be produced by deposition of a polymeric material onto a mold (master). The master, created on a silicon substrate, for example, may be generated using e-beam direct writing of a pattern into a photoresist present on the silicon substrate. Subsequently the pattern may be etched into the silicon substrate. The pattern on the silicon master mold is then replicated into the polymeric material deposited on the surface of the mold. The polymeric material may be a conformal material that exhibits sufficient rigidity to wear well when used as a contact mask against a substrate but that also can make excellent contact with the radiation-sensitive material on the substrate surface. One example of the conformal materials generally used as a transfer masking material is polydimethylsiloxane (PDMS), which can be cast upon the master mold surface, cured with UV radiation, and peeled from the mold to produce excellent replication of the mold surface.

FIG. 2 shows a cross-sectional view 200 of another embodiment of an apparatus 200 that can be used for patterning large areas of substrate material in conjunction with aspects of the present disclosure. In FIG. 2, the substrate is a film 208 upon which a pattern is imaged by radiation which passes through surface relief 212 on a first (transparent) cylinder 206 while film 208 travels from roll 211 to roll 213. The film 208 may include a layer of dry-etchable material formed on a hard-to-dry etch layer. A second cylinder 215 may be provided on the backside 209 of film 208 to control the contact between the film 208 and the first cylinder 206. The radiation source 202 which is present in the hollow space 204 within transparent cylinder 206 may be a mercury vapor lamp or another radiation source which provides a radiation wavelength of 365 nm or less. The surface relief 212 may be a phase-shift mask, for example, where the mask includes a diffracting surface having a plurality of indentations and protrusions. The protrusions are brought into contact with a surface of a positive photoresist (a radiation-sensitive material), and the surface is exposed to electromagnetic radiation through the phase mask. The phase shift due to radiation passing through indentations as opposed to the protrusions is essentially complete. Minima in intensity of electromagnetic radiation are thereby produced at boundaries between the indentations and protrusions. An elastomeric phase mask conforms well to the surface of the photoresist, and following development of the photoresist, features smaller than 100 nm (e.g., between 10 nm and 100 nm) can be obtained.

Various details of lithographic techniques that use a rotatable mask are described, e.g., in commonly-assigned co-pending U.S. patent application Ser. No. 12/384,219, filed Apr. 1, 2009, the entire disclosures of which are incorporated herein by reference. Various alternatives described therein, among others may be implemented in conjunction with aspects of the present disclosure.

For example in a specialized implementation of a light source of radiation, a flexible organic light emitting diode (OLED) display may be attached around the exterior of the rotatable mask. Light may be emitted toward the substrate from each of the LED pixels in the display. In this implementation the rotatable mask does not need to be transparent. In addition, the particular pattern to be transferred to a radiation-sensitive material on the substrate surface may be selectively generated depending on the application, through control of the light emitted from the OLED. The pattern to be transferred may be changed “on the fly” without the need to shut down the manufacturing line.

According to another aspect, to provide high throughput of pattern transfer to a radiation-sensitive material, and increase the quantity of nanopatterned surface area, it is helpful to move the substrate or the rotatable mask, such as a cylinder, against each other. The cylinder may be rotated on the substrate surface when the substrate is static or the substrate is moved relative to the cylinder while the cylinder is static.

It is useful to be able to control the amount of force which occurs at the contact line between the cylinder and the radiation-sensitive material on the surface of the substrate (for example the contact line between an elastomeric nanopatterned film present on the surface of the cylinder and a photoresist on the substrate surface). To control this contact line, the cylinder may be supported by a tensioning device, such as, for example, springs that compensate for the cylinder's weight. The substrate or cylinder (or both) may be moved (e.g., upward and downward) toward each other, so that a spacing between the surfaces is reduced, until contact is made between the cylinder surface and the radiation-sensitive material (the elastomeric nanopatterned film and the photoresist on the substrate surface, for example). The elastomeric nanopatterned film will create a bond with a photoresist via Van-der Walls forces. The substrate position is then moved back (e.g., downward) to a position at which the springs are elongated, but the elastomeric nanopatterned film remains in contact with the photoresist. The substrate may then be moved relative to the cylinder, forcing the cylinder to rotate, maintaining a dynamic contact between the elastomeric nanopatterned film and the photoresist on the substrate surface, alternatively, the cylinder can be rotated and the substrate can be moved independently, but in synchronous motion, which will assure slip-free contact during dynamic exposure.

According to some aspects of the present disclosure, multiple cylinders may be combined into one system and arranged to expose the radiation-sensitive surface of the substrate in a sequential mode, to provide double, triple, and multiple patterning of the substrate surface. This exposure technique can be used to provide higher resolution. The relative positions of the cylinders may be controlled by interferometer and an appropriate computerized control system.

According to another aspect, the exposure dose may affect the lithography, so that an edge lithography (where narrow features can be formed, which corresponds to a shift of phase in a PDMS mask, for example) can be changed to a conventional lithography, and the feature size in an imaged photoresist can be controlled by exposure dose. Such control of the exposure dose is possible by controlling the radiation source power or the rotational speed of the cylinder (exposure time). The feature size produced in the photoresist may also be controlled by changing the wavelength of the exposure radiation, light source, for example.

The masks on the cylinders may be oriented by an angle to the direction of substrate movement. This enables pattern formation in different directions against the substrate. Two or more cylinders can be placed in sequence to enable 2D patterns.

According to another aspect, the transparent cylindrical chamber need not be rigid, but may be formed from a flexible material which may be pressurized with an optically transparent gas. The mask may be the cylinder wall or may be a conformal material present on the surface of the cylinder wall. This permits the cylinder to be rolled upon a substrate which is not flat, while making conformal contact with the substrate surface.

According to yet another aspect, instead of a transparent cylinder with nanostructured polymer film laminated on its surface, one can use a free standing nanostructured polymer film, which can be moved from Roll to Roll or in the loop. In that case the pressure between such nanostructured film and a substrate can be controlled by a tension in the film and a relative position of the film and a substrate.

According to an additional aspect, a liquid having a refractive index of greater than one may be used between the cylinder surface and a radiation sensitive (photo sensitive, for example) material present on the substrate surface. Water may be used, for example. This enhances the pattern feature's contrast in the photosensitive layer.

According to further additional aspects of the present disclosure, radiation sensitive material used as a masking material may be reflown after it has been developed. Reflowing the developed radiation sensitive material may provide advantages, such as, but not limited to, providing the ability to produce sloped walls in the patterned substrate. Sloped walls in the patterned substrate allow for the fabrication of sub-wavelength anti-reflective coatings, self-cleaning coatings, and other advanced nano-structured coatings. Examples of this technique are described in commonly-assigned U.S. patent application Ser. No. 13/553,602, filed on Jul. 19, 2012, the entire contents of which are incorporated herein by reference.

While the above is a complete description of the preferred embodiments of the present invention, it is possible to use various alternatives, modifications, and equivalents. Therefore, the scope of the present invention should be determined not with reference to the above description but should, instead, be determined with reference to the appended claims, along with their full scope of equivalents. The order of recitation of steps in a method is not intended to limit a claim to a particular order of performing the corresponding steps. Any feature, whether preferred or not, may be combined with any other feature, whether preferred or not. In the claims that follow, the indefinite article “A” or “An” refers to a quantity of one or more of the item following the article, except where expressly stated otherwise. The appended claims are not to be interpreted as including means-plus-function limitations, unless such a limitation is explicitly recited in a given claim using the phrase “means for”. Any element in a claim that does not explicitly state “means for” performing a specified function, is not to be interpreted as a “means” or “step” clause as specified in 35 USC §112, ¶6.

What is claimed is:

1. A method of dry-etching a hard-to-dry-etch substrate material, the method comprising:
forming a layer of dry-etchable material on a surface of the hard-to-dry etch substrate, wherein the dry-etchable material has similar material properties to the hard-to-dry-etch substrate material is formed, wherein the dry-etchable material is one that does not produce substantial quantities of non-volatile etch byproducts that redeposit when the dry-etchable material is subject to the dry etching; and
dry etching the dry-etchable material.

2. The method of claim 1, wherein the dry-etchable material has a similar index of refraction and similar coefficient of thermal expansion (CTE) compared to the hard-to-dry-etch substrate.

3. The method of claim 1, wherein the hard-to-etch substrate material is a commercially available glass and the dry-etchable material is silica.

4. The method of claim 1, wherein the dry-etchable material is titania (TiO₂).

5. The method of claim 1, wherein dry-etching the dry-etchable material includes dry-etching the dry-etchable material in a manner that forms tapered or re-entrant features.

6. The method of claim 1, wherein forming the etch-resistant mask includes
a) providing a radiation sensitive layer on a top surface of the dry-etchable material;
b) providing a rotatable mask configured to selectively prevent a portion of the radiation sensitive layer from being exposed to radiation passing through the mask; and
c) rolling the mask over a surface of the radiation sensitive layer while passing radiation through the mask, whereby an image is created in the radiation sensitive layer, and wherein an outer surface of the rotatable mask is configured to deform when in rolling contact with a surface of the radiation sensitive layer.

7. The method of claim 6, wherein the rotatable mask includes features ranging in size from about 100 nm down to 10 nm.

8. The method of claim 6, wherein an outer surface of the rotatable mask is a conformable outer surface, which conforms to the radiation-sensitive layer on the substrate surface.

9. The method of claim 8, wherein the conformable outer surface is a shaped or nano structured polymeric material.

10. The method of claim 6, wherein the rotatable mask is a phase-shifting mask which causes the radiation to form an interference pattern in the radiation sensitive material.

11. The method of claim 6, wherein the rotatable mask employs surface plasmon behavior.

12. The method of claim 6, wherein the rotatable mask is a cylinder.

13. The method of claim 12, wherein the cylinder has a flexible wall, whereby the cylindrical shape may be deformed upon contact with the radiation sensitive material.

14. The method of claim 12, wherein the mask is a phase shifting mask which is present as a relief on a surface of the transparent cylinder.

15. The method of claim 12, wherein the mask is a phase shifting mask which is present on a layer applied over a surface of the cylinder.

16. The method of claim 12, wherein the substrate is moved in a direction toward or away from a contact surface of the rotatable cylinder during distribution of radiation from the contact surface of the cylinder.

17. The method of claim 12, wherein the cylinder is rotated on the substrate while the substrate is static.

18. The method of claim 6, wherein the rotatable mask and the substrate surface are moved independently and wherein movement of the rotatable mask and the substrate surface are synchronized with each other.

19. The method of claim 1, wherein the dry-etchable material is etched through a pattern in a masking material.

20. The method of claim 19, wherein the pattern in the masking material includes features with sloped or non-sloped walls.

21. The method of claim 1, wherein the hard-to-dry-etch substrate acts as an etch stop for the dry etching of the dry-etchable material.

22. A composition of matter, comprising:
a hard to dry-etch substrate, wherein the hard-to-dry etch substrate produces substantial quantities of non-volatile etch byproducts that redeposit when subject to the dry etching;
a layer of dry-etchable material on a surface of the hard-to-dry etch substrate, wherein the dry-etchable material has similar material properties to the hard-to-dry-etch substrate material is formed, wherein the layer of dry-etchable material includes a pattern etched into the dry-etchable material, wherein the dry-etchable material is one that does not produce substantial quantities of non-volatile etch byproducts that redeposit when the dry-etchable material is subject to the dry etching.

23. The composition of matter of claim 22, wherein the dry-etchable material has a similar index of refraction or similar coefficient of thermal expansion (CTE) compared to the hard-to-dry-etch substrate.

24. The composition of matter of claim 22, wherein the hard-to-etch substrate material is a commercially available glass and the dry-etchable material is silica.

25. The composition of matter of claim 22, wherein the dry-etchable material is Titania (TiO₂).

26. The composition of claim 22, wherein the hard-to-dry-etch substrate is configured to act as an etch stop for the dry etching of the dry-etchable material.

27. The composition of claim 22, further comprising an etch mask formed on a surface of the dry-etchable layer.

28. The composition of claim 27, wherein the etch mask includes features with sloped or non-sloped walls.
